(19) United States
(12) Patent Application Publication
(10) Pub. No.: US 2025/0267494 A1
(43) Pub. Date: Aug. 21, 2025

(54) SELF-INTERFERENCE MEASUREMENT AND REPORTING FOR A FREQUENCY BAND COMBINATION

(71) Applicant: Apple Inc., Cupertino, CA (US)

(72) Inventors: Fucheng Wang, Cupertino, CA (US); Anatoliy S. Ioffe, Sunnyvale, CA (US); Jie Cui, San Jose, CA (US); Xiang Chen, Campbell, CA (US); Yang Tang, San Jose, CA (US)

(73) Assignee: Apple Inc., Cupertino, CA (US)

(21) Appl. No.: 18/970,008

(22) Filed: Dec. 5, 2024

Related U.S. Application Data
(60) Provisional application No. 63/554,127, filed on Feb. 15, 2024.

(51) Int. Cl. H04W 24/10; H04B 17/309; H04B 17/318

(52) U.S. Cl. CPC H04W 24/10; H04B 17/318; H04B 17/346

(57) ABSTRACT

The present application relates to performing and reporting a self-interference measurement of a user equipment (UE) for a frequency band combination to assist with managing, at least in part, the UE's use of the frequency band combination. In an example, the self-interference measurement can include any or a combination of a maximum sensitivity degradation (MSD) measurement or a signal to interference ratio (SIR) measurement due to interference between an uplink transmission and a downlink transmission of the UE on the frequency band combination. Different triggers are possible to perform the self-interference measurement such as a configuration change to the UE or an acceptable inter-cell interference measurement. Based on the self-interference measurement, a network can enable the UE to use the frequency band combination or can initiate a mitigation action.

### CROSS-REFERENCES TO RELATED APPLICATIONS

This application claims priority to U.S. Provisional Application No. 63/554,127, for “SELF-INTERFERENCE MEASUREMENT AND REPORTING FOR A FREQUENCY BAND COMBINATION” filed on Feb. 15, 2024, which is herein incorporated by reference in its entirety for all purposes.

### BACKGROUND

Fifth generation mobile network (5G) is a wireless standard that aims to improve upon data transmission speed, reliability, availability, and more. This standard, while still developing, includes numerous details related to, for instance, a user equipment (UE) communicating with a network to send and receive data. In an example, multiple frequency bands are used for the communication.

### BRIEF DESCRIPTION OF THE DRAWINGS

FIG. 1 illustrates an example of a network environment, in accordance with some embodiments.

FIG. 2 illustrates a schematic diagram of a receiver of a user equipment (UE) and use thereof to determine a maximum sensitivity degradation (MSD) measurement, in accordance with some embodiments.

FIG. 3 illustrates a schematic diagram of a receiver of a UE and use thereof to determine a signal to interference ration (SIR) measurement, in accordance with some embodiments.

FIG. 4 illustrates an example of an operational flow/algorithmic structure for a performing an MSD measurement, in accordance with some embodiments.

FIG. 5 illustrates an example of an operational flow/algorithmic structure for performing a SIR measurement, in accordance with some embodiments.

FIG. 6 illustrates an example of inter-cell interference-based trigger to perform a self-interference measurement, in accordance with some embodiments.

FIG. 7 illustrates an example of a UE configuration-based trigger to perform a self-interference measurement, in accordance with some embodiments.

FIG. 8 illustrates an example of an operational flow/algorithmic structure for performing a self-interference measurement based on a set of triggers, in accordance with some embodiments.

FIG. 9 illustrates another example of an operational flow/algorithmic structure for performing a self-interference measurement based on a set of triggers, in accordance with some embodiments.

FIG. 10 illustrates another example of an operational flow/algorithmic structure for validating a received signal strength indicator (RSSI)-based MSD measurement, in accordance with some embodiments.

FIG. 11 illustrates an example of receive components, in accordance with some embodiments.

FIG. 12 illustrates an example of a UE, in accordance with some embodiments.

FIG. 13 illustrates an example of a network device, in accordance with some embodiments.

### DETAILED DESCRIPTION

Embodiments of the present disclosure relate to, among other things, self-interference measurements and reporting for frequency band combinations. A user equipment (UE) can report a self-interference measurement for a frequency band combination to a network. The measurement can assist the network with managing, at least in part, the UE's use of the frequency band combination.

In an example, the network configures the frequency band combination for the UE. Upon a trigger, the UE (or processing circuitry thereof) can perform or complete performing the self-interference measurement. Generally, the self-interference measurement can represent a measurement of an interference between a receive path and a transmit path of the UE when the frequency band combination is used. Different self-interference measurement types are possible including, for example, a maximum sensitivity degradation (MSD) measurement and a signal to interference (SIR) measurement. Different trigger types are also possible. A first example trigger can include a determination that an inter-cell measurement is within a measurement range from a reference sensitivity (REFSENS) measurement (e.g., the difference between the two is less than 6 dB, or some other predefined threshold value). The inter-cell measurement can be an estimation of the interference from a neighbor cell. The REFSENS measurement can be an expected measurement when no inter-cell interference exists. A second example trigger can include a change to a configuration of the receive path (e.g., upon a UE hardware antenna configuration change, the self-interference measurement is triggered). Other triggers are also possible, such as a network-based determination that self-interference may occur for the band combination.

In the various examples, the UE performs and reports the self-interference measurement to the network. Based on the self-interference measurement, the network can manage, at least in part, the UE's use of the frequency band combination. For example, if the self-interference measurement is smaller than a threshold value (e.g., the self-interference does not substantially degrade the quality of the communications), the network can schedule uplink transmission and downlink reception on the first frequency band and the second frequency band, respectively. Otherwise, the network can initiate a mitigation action. A first example mitigation action includes activating or configuring a different frequency band combination for the UE. A second example mitigation action includes deactivating the uplink transmission or the downlink transmission. A third example mitigation action includes activating a different bandwidth part within a frequency band of the band combination. A fourth mitigation action includes changing the resource scheduling within the frequency band. Other actions are also possible and are further described herein below.

Accordingly, the use of network resources (e.g., frequency bands, bandwidth parts, resource blocks, etc.) can be improved by using real-time operational measurements by the UE. By using certain triggers, the overhead associated with measuring and reporting self-interference measurements can be reduced. Further, the use of certain triggers can avoid the need to perform a self-interference measurement when unnecessary. Accordingly, the overall data throughout can be improved because the use of measurement gaps can be reduced (e.g., whereby performing a self-interference measurement may involve the use of a measurement gap).

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes. The term “processor circuitry” may be used synonymously with the term “processing circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

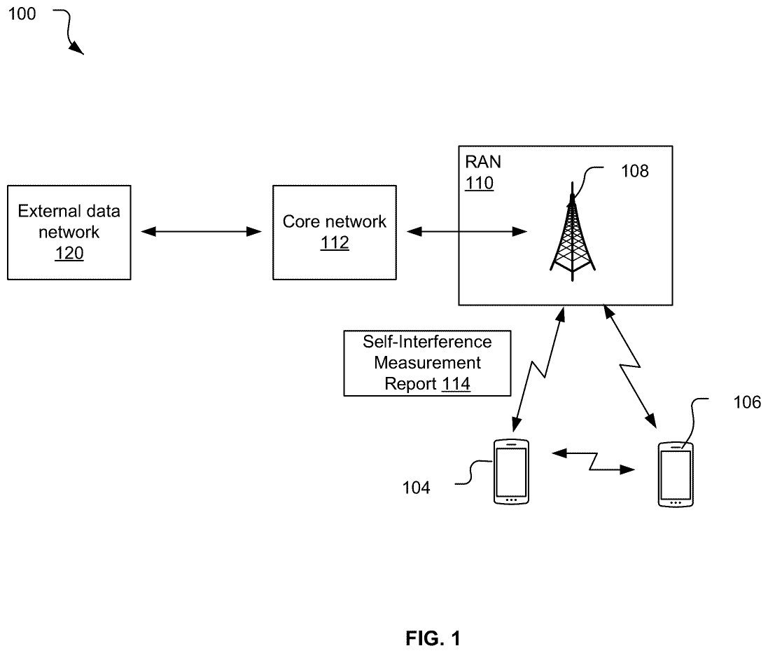

FIG. 1 illustrates a network environment 100 in accordance with some embodiments. The network environment 100 may include a UE 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104. As further described herein below, the UE 104 can send a self-interference measurement report 114 to the base station 108. The self-interference measurement report 114 can indicate an MSD value and/or an SIR value. The base station 108 can manage, at least in part, the UE's 104 use of frequency bands based on the self-self-interference measurement report 114.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5th Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

The base station 108 may transmit information (for example, data and control signaling) in the downlink direction by mapping logical channels on the transport channels and transport channels onto physical channels. The logical channels may transfer data between a radio link control (RLC) and MAC layers; the transport channels may transfer data between the MAC and PHY layers; and the physical channels may transfer information across the air interface. The physical channels may include a physical broadcast channel (PBCH), a physical downlink control channel (PDCCH), and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in an SSB. The SSBs may be used by the UE 104 during a cell search procedure (including cell selection and reselection) and for beam selection.

The PDSCH may be used to transfer end-user application data, signaling radio bearer (SRB) messages, system information messages (other than, for example, MIB), and SIs.

The PDCCH may transfer DCI that is used by a scheduler of the base station 108 to allocate both uplink and downlink resources. The DCI may also be used to provide uplink power control commands, configure a slot format, or indicate that preemption has occurred.

The base station 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include a channel status information reference signal (CSI-RS). The CSI-RS may be a multi-purpose downlink transmission signal that may be used for CSI reporting, beam management, connected mode mobility, radio link failure detection, beam failure detection and recovery, and fine-tuning of time and frequency synchronization. Similarly, the UE can transmit reference signals to the base station 108 for measurements to be performed by the base station 108 (e.g., in use cases where reciprocity is not assumed between a downlink channel and an uplink channel). These reference signals can include, for example, a sounding reference signal (SRS).

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain and one orthogonal frequency division multiplexing (OFDM) symbol in the time domain. Twelve consecutive subcarriers in the frequency domain may compose a physical resource block (PRB). A resource element group (REG) may include one PRB in the frequency domain and one OFDM symbol in the time domain, for example, twelve resource elements. A control channel element (CCE) may represent a group of resources used to transmit PDCCH. One CCE may be mapped to a number of REGs, for example, six REGs.

The UE 104 may transmit data and control information to the base station 108 using physical uplink channels. Different types of physical uplink channels are possible including, for instance, a physical uplink control channel (PUCCH) and a physical uplink shared channel (PUSCH). Whereas the PUCCH carries control information from the UE 104 to the base station 108, such as uplink control information (UCI), the PUSCH carries data traffic (e.g., end-user application data) and can carry UCI.

The UE 104 and the base station 108 may perform beam management operations to identify and maintain desired beams for transmission in the uplink and downlink directions. The beam management may be applied to both PDSCH and PDCCH in the downlink direction and PUSCH and PUCCH in the uplink direction.

In an example, communications with the base station 108 can use channels in the frequency range 1 (FR1), frequency range 2 (FR2), and/or a higher frequency range (FRH). The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device should apply a clear channel assessment (CCA) check before using the channel.

In an example, the UE 104 supports carrier aggregation (CA), whereby the UE 104 can connect and exchange data simultaneously over multiple component carriers (CCs) with the base station 108. The CCs can belong to the same frequency band, in which case they are referred to as intra-band CCs. Intra-band CCs can be contiguous or non-contiguous. The CCs can also belong to different frequency bands, in which case they are referred to as inter-band CCs. A serving cell can be configured for the UE 104 to use a CC. A serving cell can be a primary (PCell) or a secondary cell (SCell). Multiple SCells can be activated via an SCell activation procedures where the component carriers of these serving cells can be intra-band contiguous, intra-band non-contiguous, or inter-band. The serving cells can be collocated or non-collocated.

The UE 104 can also support dual connectivity (DC), where it can simultaneously transmit and receive data on multiple CCs from two serving nodes or cell groups (a master node (MN) and a secondary node (SN)). DC capability can be used with two serving nodes operating in the same RAT or in different RATs (e.g., an MN operating in NR, while an SN operates in LTE). These different DC modes include, for instance, evolved-universal terrestrial radio access-new radio (EN)-DC, NR-DC, and NE-DC (the MN is a NR gNB, and the SN is an LTE eNB).

In support of dual connectivity, the UE 104 can report its capability to support frequency band combinations. A frequency band combination corresponds to a set of two or more frequency bands from the same frequency range or different frequency ranges (e.g., LTE and/or NR bands from FR1 and/or FR2 (as applicable)). For instance, a frequency band combination is denoted as “n1, n2, n3” and corresponds to a combinations of three NR frequency bands from FR1: “NR band n1,” “NR band n2,” and “NR band n3.”

For each frequency band combination, the UE 104 can report whether the UE 104 supports the frequency band combination for dual connectivity. In other words, the UE 104 can indicate whether carriers in the frequency bands of the band combinations can be supported by the UE 104 for the dual connectivity. For instance, the UE 104 reports to the network (e.g., the MN) UE capability information indicating that it supports the frequency band combination “n1, n2, n3” for dual connectivity. In this case, the network can configure carriers (e.g., serving cells) from the corresponding NR bands (e.g., “NR band n1,” “NR band n2,” and “NR band n3”) for dual connectivity of the UE 104.

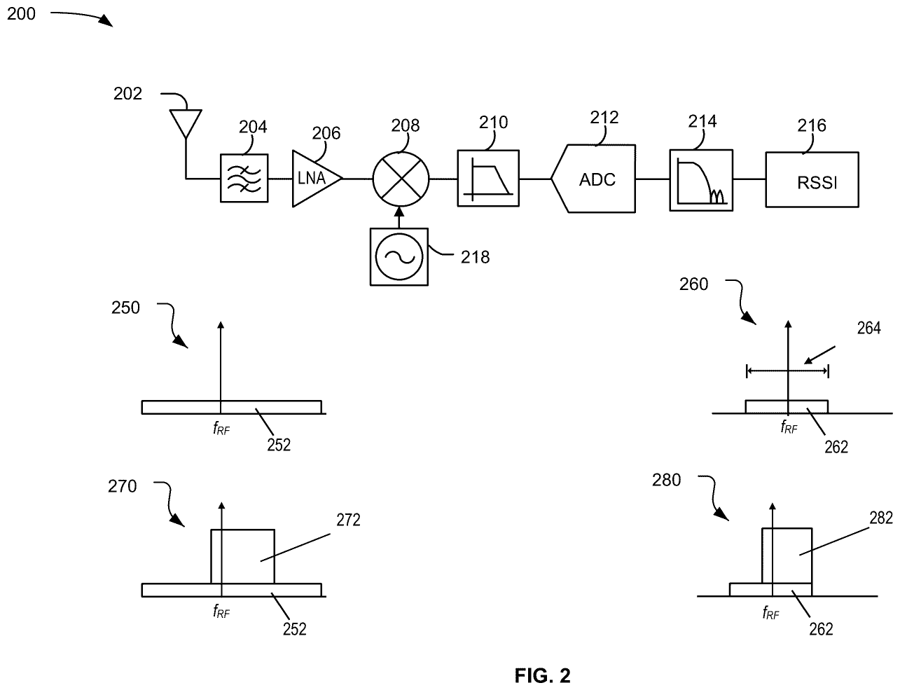

FIG. 2 illustrates a schematic diagram of a receiver 200 of a UE and use thereof to determine a maximum sensitivity degradation (MSD) measurement, in accordance with some embodiments. The UE is an example of the UE 104. As illustrated, the receiver 200 includes an antenna 202, a band-pass filter (BPF) 204, a low noise amplifier (LNA) 206, a mixer 208, an analog baseband and/or low pass filter (LPF) 210, an analog-to-digital converter (ADC) 212, a digital channel filter 214, and a power detector 216.

In operation, the receiver 200 may receive a received signal via the antenna 202 at the BPF 204, which may filter undesired frequencies or frequency bands from the received signal. The LNA 206 may then amplify the band-pass filtered signal. The amplified signal may be mixed, using the mixer 208, with a local oscillation signal provided by a local oscillator (LO) 218, and then be passed through the LPF 210. The ADC 212 may then convert the signal to a digital format, and the digital signal may then be input to the digital channel filter 214, which may be implemented as a finite impulse response (FIR) filter. The digital channel filter 214 may filter the digital signal to enable pass through of the signal within a desired channel bandwidth, resulting in an output signal. The power detector 216 may determine or measure a power (or received signal strength indicator (RSSI)) of the signal output by the digital channel filter 214.

In an example, the receiver 200 can be a component of a receive path (possibly one of many receive paths) of the UE. A transmitter of the UE can be used to transmit an uplink signal on a frequency band, whereas the receiver can be used to receive a downlink signal on the same or a different frequency band. Self-interference can occur between the receiver and the transmitter (or, equivalently, between the receive path and a transmission path). Such an interference can be from one frequency band to another frequency band, where such two frequency bands belong to a frequency band combination that the UE can support.

In 3GPP, the impact of self-interference to reference sensitivity (also referred to as REFSENS) degradation of the receiver 200 for a frequency band combination has been defined as the Maximum Sensitivity Degradation (or MSD) in units of decibels (dB). REFSENS is defined as the minimum receive signal power level which may be demodulated by the receiver 200 to achieve a certain threshold percentage of data throughput under a digital signal modulation scheme, such as quadrature phase shift keying (QPSK). The MSD value may be generally referred to as a sensitivity degradation value of the receiver 200 of the UE. Depending on carrier configurations and interference mechanism, the MSD value may range from low single digit dB to 30+dB based on linearity and isolation performance of radio frequency front-end components (e.g., amplifiers, filters, and so on). It should be understood that “carrier” as used herein refers to component carrier and may include a unit of frequency range or bandwidth that a network may assign to the UE for wireless transmission and/or reception, and “carrier combination” as used herein may include a combination of multiple carriers assigned to the UE by the network (e.g., indicated at a single time, via a radio resource control (RRC) configuration) for wireless transmission and/or reception (e.g., simultaneously or at different times).

There is concern for frequency band combinations with MSD above 20 dB, as resulting communications may be poorer quality, which may restrict usage of certain carrier configurations and render network operators to become less interested in configuring those frequency combinations for the UE. However, MSD has been defined as the minimum requirement under a worst-case test configuration. It was not originally meant to be used for network scheduling, nor as a criterion for whether a frequency band combination may be configured for the UE, but as an indirect way of verifying performance of the radio frequency front-end components of the UE.

That is, in most cases, MSD for the UE (e.g., when in use by a consumer) may have better performance than that specified for a test configuration (e.g., as performed when the UE is manufactured). As some UE in the field have seen better MSD performance than what is defined in the 3GPP specifications, proposals have been introduced to the 3GPP to support frequency band combination for the UE having improved (e.g., lower) MSD. For example, such proposals introduce a capability to enable the UE to indicate support for the improved MSD.

However, as proposed, this capability may only be reported at a specified worst-case carrier configuration, but not necessarily, and indeed likely not, for the MSD for the configuration scheduled by the network, which could potentially negatively impact the network's scheduling efficiency. Without in-situ MSD measurement (e.g., real-time measurement of MSD performed during operations of the UE), the UE may instead store all pre-measured MSD values for all supported band combinations with MSD impact, which may be an excessive load on the memory of the UE. Additionally, MSD measurement may include a time-consuming process, which could substantially increase factory test cost per user equipment. Further, depending on granularity for storing the MSD values (e.g., a number of bits used to represent each MSD value), the reported MSD threshold may have a large tolerance to the exact MSD.

The disclosed embodiments include configuration-based MSD reporting, which may be triggered based on a set of conditions. In particular, the UE can indicate to the network a change to its hardware configuration (e.g., a configuration change to one of its receive paths). In turn, the network can trigger the UE to perform MSD reporting. In another example, the UE (and/or the network) can determine that the impact of interference from a neighbor cell is minimal, where this impact can trigger the UE to proceed (or the network to request) the MSD measurement. Further, the network may perform MSD occurrence pre-screening (e.g., determine whether the particular frequency band or carrier combination may result in interference) to decide whether to cause or instruct the UE to perform and report the MSD measurement.

Configuration-based MSD reporting may be performed either semi-statically (e.g., when a new frequency band or carrier combination is assigned to the UE, when the RRC configuration changes, and so on) or dynamically (e.g., under the same carrier configuration, but retriggered when some other condition changes, such as UE UL power and resource allocations, and so on). Upon receiving the MSD value from the UE, the network or the base station may schedule the UE for wireless transmission/reception using the carrier combination based on the MSD value. For example, the network may compare the MSD value to an MSD threshold. If the MSD value does not exceed the threshold, then the network may schedule or configure the UE to use the carrier combination. If the MSD value exceeds the threshold, then the network may perform a mitigation action, such as downgrading transmission or reception of data, such as by only scheduling one carrier of the carrier combination to the UE, only scheduling a master cell group in a dual-connectivity (DC) combination, only scheduling a primary cell (PCell) operation in a carrier aggregation (CA) combination, disabling secondary cell (SCell) uplink transmission in a two-uplink (2UL) CA combination, disabling SCell downlink reception if it is impacted by either PCell uplink or both PCell and SCell uplink intermodulation product, or even not scheduling any operation for the UE. As another example, the network or the base station may implement MSD-aware scheduling, where the modulation and coding rate configurations for the impacted downlink carriers are determined based on the user equipment's reported degradation in sensitivity. In yet another example, the network can configure or activate the use of a different bandwidth part (BWP) on a frequency band. In a further example, the network can change or schedule a different resource allocation within a frequency band.

Continuing with the description of FIG. 2, herein next is an explanation of how an MSD measurement can be performed. In FIG. 2, plot 250 illustrates a noise floor 252 of the UE. The horizontal axis of the plot 250 represents frequency (e.g., in Hertz), and the vertical axis of the plot 250 represents power (e.g., in dBm). The noise floor 252 of the UE may refer to what the antenna 202 may receive when no downlink transmission is sent from the base station to the UE (e.g., no downlink signal is transmitted to the UE). “fRF” may represent a center frequency for a channel or carrier assigned to the UE by the network.

Plot 260 of FIG. 2 illustrates a REFSENS 262 of the UE. When received by the receiver 200, the noise floor 252 may be filtered by the digital channel filter 214, which may block the noise floor 252 outside a configured UE channel bandwidth 264 of the channel or carrier. The remaining noise floor that passes through the digital channel filter 214 may be referred to as the REFSENS 262 for digitally modulated signal with SNR requirement at 0 dB. The UE may then cause the power detector 216 to determine or measure a power of the REFSENS 262, generating a REFSENS power value.

Plot 270 of FIG. 2 illustrates an aggressor uplink-induced interference 272 of the UE. In particular, the UE may receive an allocated carrier combination from the network. The UE may then set an output power of its transmitter to a predetermined value and transmit certain uplink signals. The predetermined value may include a maximum transmission power of the transmitter as defined by a standards body (e.g., 3GPP) via any suitable specification (e.g., which may be referred to as PCMAX). As such, the predetermined value may be based on any number of factors, such as a serving cell of the network, signaling by the base station, a carrier frequency, a power class of the UE, a maximum power reduction (MPR) taking into account modulation versus the configured UE channel bandwidth and transmission bandwidth, an allowed additional maximum power reduction (A-MPR) to account for ACLR (Adjacent Channel Leakage Ratio), spectrum emission and spurious emission requirements for carrier aggregation, an allowed maximum output power reduction (P-MPRc) to ensure compliance with applicable electromagnetic energy absorption requirements and addressing unwanted emissions requirements in case of simultaneous transmissions on multiple radio access technologies or to ensure compliance with applicable electromagnetic energy absorption requirements in case of proximity detection is used to address such requirements that require a lower maximum output power, a bandwidth of the channel, and so on. It should be noted that the UE may receive an indication to transmit these uplink signals, either from a processor of the UE and/or from the network via the base station. The uplink signals transmitted by the transmitter may include test signals that, for example, mimic or represent signals to be transmitted (e.g., during operation, with data payload, and so on).

As illustrated, the aggressor uplink-induced interference 272 may be offset from and/or not be centered at the center frequency of the carrier and/or channel. Plot 280 of FIG. 2 illustrates the aggressor uplink-induced interference filtered by the digital channel filter 214 of the receiver 200, along with the REFSENS 262. That is, when received by the receiver 200, the interference may be filtered by the digital channel filter 214, which may block the interference outside the channel or configured UE channel bandwidth. The remaining interference that passes through the digital channel filter 214 may be referred to as channel or carrier interference 282. The UE may (e.g., its processor) then cause the power detector 216 to determine or measure a power of the carrier interference 282, generating a carrier interference power value, P_{interference}. As illustrated, when determining or measuring the power of the carrier interference 282, the power of the REFSENS 262 may also be captured. However, deviation due to the REFSENS 262 may be at most 3 dB, which may be negligible. Moreover, because P_{interference} is typically greater (e.g., much greater, 10 dB to 15 dB greater) relative to the REFSENS value, P_{interference} may dominate the determination or measurement of the carrier interference by the power detector 216, which may be preferable.

With the REFSENS value and the P_{interference} value (e.g., stored in the memory of the UE), the UE's processor may determine or estimate the MSD measurement by determining a difference between the two power values (e.g., “MSD measurement=Pinterference−REFSENS”). The UE may then transmit and/or report the MSD measurement (e.g., via its transmitter) to the network via the base station, which may then evaluate the MSD value (e.g., compare the MSD value to a threshold) and determine whether to schedule or configure the UE for the carrier combination or perform a mitigation action.

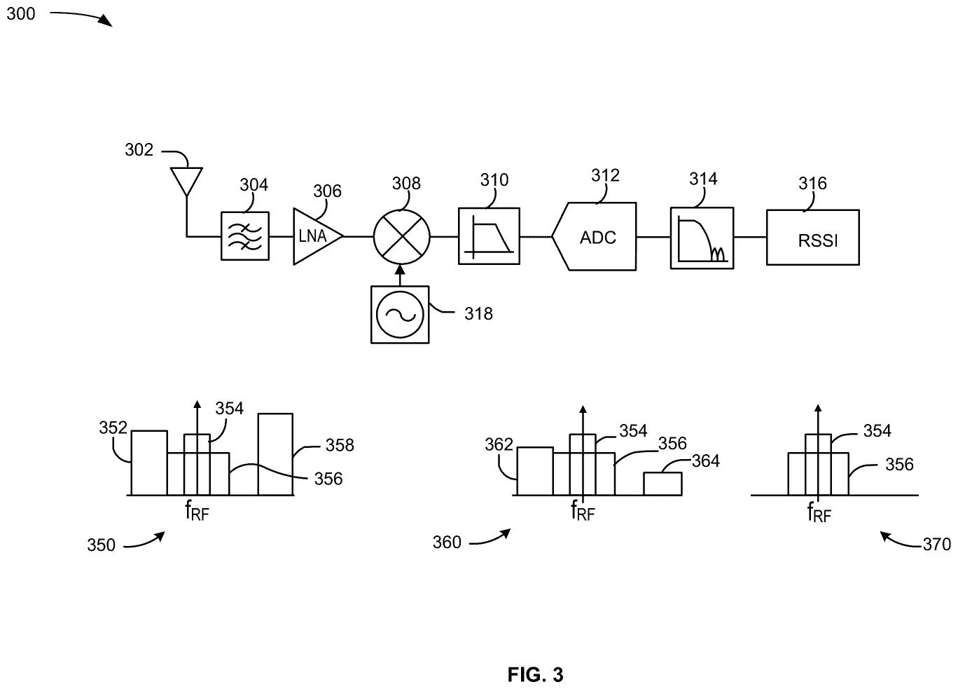

FIG. 3 illustrates a schematic diagram of a receiver 300 of a UE and use thereof to determine a signal to interference ration (SIR) measurement, in accordance with some embodiments. The UE is an example of the UE 104. As illustrated, the receiver 300 includes an antenna 302, a BPF 304, an LNA 306, a mixer 308, an LPF 310, an ADC 312, a digital channel selection filter 314, and a power detector 316, similar to the components of the receiver 200.

The antenna 302 of the receiver 300 may receive a received signal (represented by plot 350), which may include a desired or wanted signal 356 (which may have a center radio frequency of fRF), along with undesired interference or noise, such as adjacent channel interference 352, co-channel interference 354, and an in-band blocker 358. In some cases, the received signal may also include an out-of-band blocker (not shown). The received signal is passed through various components of the receiver 300 to remove (or reduce) the out-of-band blocker, the in-band blocker 358, and/or adjacent channel interference 352.

For example, the received signal is passed through the BPF 304 which may filter undesired frequencies or frequency bands from the received signal, and then through the LNA 306 which may amplify the band-pass filtered signal. The amplified signal may be mixed, using the mixer 308, with a local oscillation signal provided by a local oscillator 318, and then be passed through the LPF 310. The signal output by the LPF 310 (e.g., a post-LPF signal represented by plot 360) may include decreased amplitudes with respect to the adjacent channel interference 352 (shown as adjacent channel interference 362) and/or the in-band blocker 358 (shown as in-band-blocker 364), as illustrated, so that the ADC 312 may have sufficient dynamic range to convert the post-LPF signal. The ADC 312 may then convert the signal to a digital format, and the digital signal may then be input to the digital channel selection filter 314, which may be implemented as a finite impulse response (FIR) filter. The digital channel selection filter 314 may filter the remaining adjacent channel interference 362 and/or in-band blocker 364 from the post-LPF signal, resulting in an output signal (represented by plot 370) with the desired signal 356 and the remaining co-channel interference 354.

The power detector 316 may determine or measure a power (e.g., received signal strength indicator (RSSI)) of the signal output by the digital channel selection filter 314, including the desired signal 356 and the co-channel interference 354. That is, the power detector 316 may determine or measure a total power (or RSSI) of the desired signal 356 and the co-channel interference 354, combined (if both are present). To determine or measure a SIR of the received signal (shown in the plot 350), the power detector 316 may determine or measure a power (or RSSI) of the desired signal 356 (e.g., at the antenna 302), and separately (e.g., independently) determine or measure a power (or RSSI) of the co-channel interference 354 (e.g., at the antenna 302), which may then enable a processor of the UE to determine the SIR of the received signal based on the power of the desired signal 356 and the power of the co-channel interference 354. Advantageously, the power detector 316 can measure or determine the power (or RSSI) of the desired signal 356 separately from the power (or RSSI) of the co-channel interference 354. In this way, the UE can compute the SIR of the received signal (represented by the plot 350) and report the SIR to the communication network to facilitate scheduling of the frequency band combination.

The SIR may refer to a measure of an average power of a received modulated signal to a measure of an average power of the interference. Like MSD, SIR can be used to manage at least in part the UE's of a frequency band combination. Further, MSD for a frequency band combination may vary substantially depending on the presence or absence of SIR. If no SIR detection mechanism is implemented and used on the UE side, then the network may erroneously determine that the UE is subject to the MSD (e.g., a worst case MSD) as defined in, for example, a 3GPP technical specification, and scheduling of the frequency band combination may become inefficient. In fact, in a worst case scenario, these frequency band combinations may never be scheduled for any UE in any circumstance, even though their actual MSD performance may be much better than that defined (e.g., specified) by the specification (under many operation scenarios).

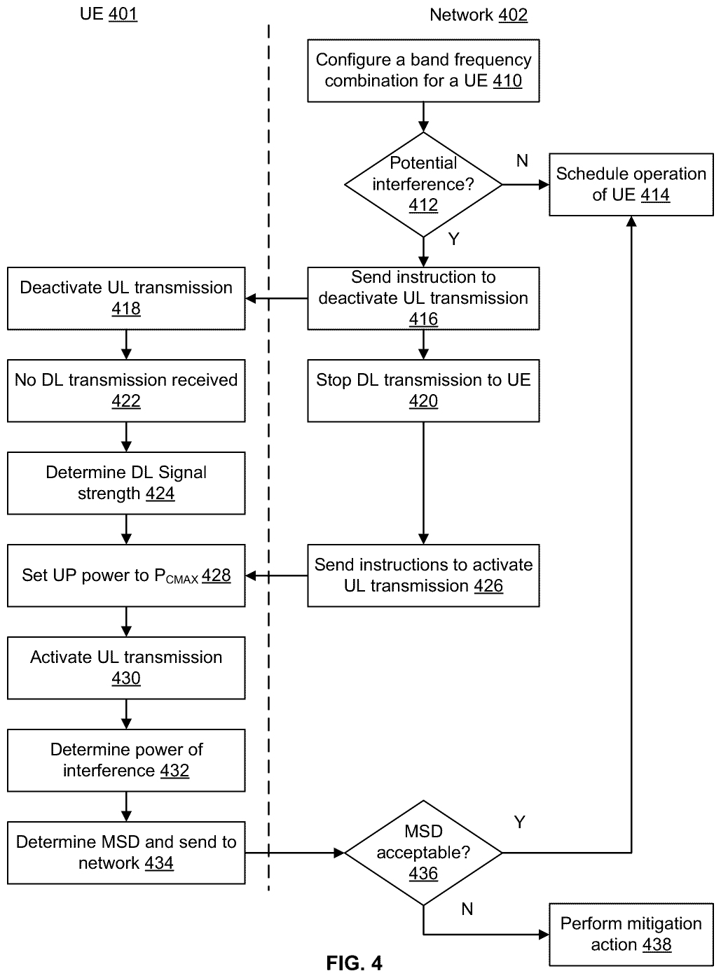

FIG. 4 illustrates an example of an operational flow/algorithmic structure 400 for performing an MSD measurement, in accordance with some embodiments. The operational flow/algorithmic structure 400 can be implemented by a UE 401 and a network 402 (e.g., performed by components thereof including, for example, processors of the UE 401 and/or processors of a base station of the network 402). The UE 401 and the network 402 can be any of the UE and networks described herein. In some embodiments, the operational flow/algorithmic structure 400 may be implemented by executing instructions stored in a tangible, non-transitory, computer-readable storage medium, such as a memory of the UE 401 and/or a memory of the base station. While the operational flow/algorithmic structure 400 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 400 includes, at 410, the network 402 configuration a frequency band combination for the UE 401. The frequency band combination may include any suitable combination of frequency bands for uplink and/or downlink, as well as any suitable frequency bands (e.g., Evolved Universal Mobile Telecommunications System (UMTS) Terrestrial Radio Access (EUTRA)/NR bands 20, n8, and so on). In particular, the frequency band combination may include a combination of multiple component carriers, which may be included in different frequency bands or the same frequency band.

In an example, the operational flow/algorithmic structure 400 includes, at 412, the network 402 determining if there is potential or a likelihood of interference (e.g., self-interference, such as intermodulation or harmonic interference) that would occur between the frequency bands if the UE 401 were to operate (e.g., perform downlink or uplink operations) on the frequency bands. For example, for a two-frequency band combination, the network 402 may determine whether there is potential interference based on the following equations and the Table 1 below:

$${f}_{iNT} = a \times {f}_{TX 1} + b \times {f}_{RX 1} + C \times {f}_{TX 2} + d \times {f}_{RX 2} \qquad ( Equation 1 )$$

$${BW}_{iNT} = \vert a \vert \times {CBW}_{TX 1 + \vert C \vert \times } {CBW}_{TX 2} \qquad ( Equation 2 )$$

$$\vert {f}_{iNT} \vert < \frac{{Bw}_{iNT} {CBW}_{RX 1}}{2} \qquad ( Equation 3 )$$

$$\vert {f}_{iNT} \vert < \frac{{Bw}_{iNT} {CBW}_{RX 2}}{2} \qquad ( Equation 4 )$$

where, assuming the interference is limited to up to 5th order mixing products:
“a” is an integer with a range between −5 and +5;
“b” is either −1, 0, or +1;
“c” is an integer with a range between −5 and +5;
“d” is either −1, 0, or +1;
f_{INT} is the interference center frequency after receiver frequency down conversion;
BW_{INT} is the effective bandwidth (BW) of the interference (INT);
CBW_{TX1} is the uplink carrier channel BW for component carrier “CC1;”
CBW_{TX2} is the uplink carrier channel BW for “CC2;”
CBW_{RX1} is the downlink carrier channel BW for “CC1;” and
CBW_{RX2} is the downlink carrier channel BW for “CC2.”

TABLE 1

| | | | | | | Harmonic/ | | |
|---|---|---|---|---|---|---|---|---|
| EUTRA-NR | EUTRA/NR | | | | | IMD | Victim | Interf. |
| DC Config. | Band | UL Coeff. | | DL Coeff. | | Order | Band | Type |
| DC_20A_n8A | 20 | a | 2 | b | −1 | 3 | 20 | IMD |
| | n8 | c | −1 | d | 0 | | | |
| DC_20A_n8A | 20 | a | 3 | b | −1 | 5 | 20 | IMD |
| | n8 | c | −2 | d | 0 | | | |
| DC_20A_n8A | 20 | a | −2 | b | 0 | 5 | N8 | IMD |
| | n8 | c | 3 | d | −1 | | | |

Table 1 and the Equations (1)-(4) above may be used by the network 402 to determine an uplink carrier frequency and a downlink carrier frequency for a particular band configuration. Based on the uplink and/or downlink carrier frequencies, the network 402 may determine whether there is interference generated from the uplink side that would affect (e.g., fall onto) the downlink carrier. The network 402 may determine some of the coefficients for the uplink and downlink, respectively, for each band combination prior to configuring the UE 401 for the band combination. The network 402 may use Equations (3) and (4) to determine when the co-channel interference is overlapping the downlink carrier channel for “CC1” and “CC2,” respectively. For example, if Equation (3) is true, the interference overlaps (e.g., falls within) the downlink carrier channel bandwidth for “CC1.” Similarly, if Equation (4) is true, the interference overlaps the downlink carrier channel bandwidth for “CC2.”

As shown in Table 1, the network 402 may also determine an interference type, such as intermodulation (IMD) interference or harmonic interference. The coefficients may be related to the type of interference type. The network 402 may also determine a harmonic order of the interference. Advantageously, the information in Table 1 may be determined by the network 402 before configuring the UE 401 for a particular frequency band combination.

If the inequality of Equation (3) is met, then there is potential interference impacting “downlink carrier 1.” If the inequality of Equation (4) is met, then there is potential interference impacting “downlink of carrier 2.” It should be understood that the use of Table 1 is only one example of determining whether there is potential interference in a carrier combination, and any suitable method, including those adopted by any suitable standard body (including 3GPP) is contemplated. This determination may be referred to as an MSD occurrence pre-screening process.

If there is no potential interference, the network 402 can schedule an operation of the UE 401 on the combination of frequency bands or carriers at 414 of the operational flow/algorithmic structure 400. The UE 401 may then transmit and receive signals using the carrier combination.

If the network 402 determines there is potential interference impacting any of the downlink carriers, then the network 402 may send an instruction to the UE 401 to deactivate uplink transmissions (e.g., uplink signals) at 416 of the operational flow/algorithmic structure 400. Additionally, or alternatively, the network 402 may send an indication to the UE 401 to determine the MSD value (which may include an implicit or explicit instruction to the UE 401 to deactivate uplink transmissions).

In an example, the operational flow/algorithmic structure 400 includes, at 418, the UE 401 deactivating uplink transmissions. In some examples, the UE 401 may deactivate uplink transmissions that are cross-band with or may affect operation on the frequency band combination, while, in other examples, the UE 401 may deactivate all uplink transmissions.

In an example, the operational flow/algorithmic structure 400 includes, at 420, the network 402 stopping downlink transmissions (e.g., downlink signals) to the UE 401. As such, the UE 401 receives no downlink transmissions from the UE 401 (e.g., the channel is empty of transmissions) as shown at 422 of the operational flow/algorithmic structure 400.

In an example, the operational flow/algorithmic structure 400 includes, at 424, the UE 401 determining or measuring downlink signal strength or RSSI (e.g., on the allocated carrier combination, on “downlink carrier 1,” “downlink carrier 2,” or both) using a power detector, thus determining or measuring the REFSENS. The UE 401 can measure or determine the REFSENS without at least self-interference caused by uplink transmissions or aggressors or downlink receptions or aggressors (e.g., because at least cross-band uplink transmissions are deactivated on the UE 401). In some examples, the REFSENS value may be pre-measured or pre-determined and stored (e.g., in a memory of the UE 401), thus obviating performance of some of the above described operations, though performance of such operations may yield a more accurate MSD value as the REFSENS value is measured or determined during operation and with real-world, actual use parameters. In some examples, an RSSI measurement is performed on symbols without scheduled downlink reference signals. Such symbols are unassociated with a downlink reference signal configured for the UE 401 and transmitted by the network 402 to the UE 401. If a symbol is scheduled for downlink to the UE 401, the RSSI measurement is not performed on such symbol.

In an example, the operational flow/algorithmic structure 400 includes, at 426, the network 402 sending an instruction to the UE 401 to activate uplink transmissions (e.g., the uplink aggressors) that may cause the self-interference (e.g., self-generated interference). While the disclosure may refer to activating uplink transmissions, it should be understood that, at least in some examples, the instruction to the UE 401 may additionally or alternatively include activating downlink receptions (e.g., downlink aggressors) that may cause the self-interference.

In an example, the operational flow/algorithmic structure 400 includes, at 428, the UE 401 setting uplink or transmission power of its transmitter to a predetermined value. The predetermined value may include a maximum transmission power of the transmitter as defined by a standards body (e.g., 3GPP) via any suitable specification (e.g., which may be referred to as PCMAX). In some examples, the UE 401 may receive an indication from the network 402 to set the transmission power to the predetermined value, while in additional or alternative examples, the indication may be generated and received from the UE 401 (e.g., the processor thereof). In particular, the UE 401 may set the transmission power of the transmitter to the predetermined value via an open-loop power control procedure, a closed-loop power control procedure, or an MSD test function. The open-loop power control procedure may include the network 402 indicating to the UE 401 to perform uplink transmissions with a specified power that the UE 401 cannot reach in order to force the UE 401 transmit at a maximum power (e.g., corresponding to the predetermined value). The closed-loop power control procedure may include the network 402 indicating (e.g., via transmit power control commands) that the UE 401 should increase its transmission power by a specified increment, such as 1 dB, 2 dB, 5 dB, dB and so on. The MSD test function may include the UE 401 automatically setting the transmission power of the transmitter to the predetermined value as instructed by the network 402 (e.g., without indication of the predetermined value by the network 402). In some examples, the predetermined value may be lower than the maximum transmission power of the transmitter. For example, it may be useful for the network 402 to receive MSD values corresponding to transmission power of the transmitter at lower than maximum transmission powers (e.g., with a power back-off applied). Accordingly, the network 402 may instruct the UE 401 to determine the MSD value with lower than maximum transmission powers (e.g., with one or more power back-offs applied), in addition to or instead of the MSD value determined with the maximum transmission power.

In an example, the operational flow/algorithmic structure 400 includes, at 430, the UE 401 activating uplink transmissions. For example, the UE 401 may send one or more test signals to the base station (e.g., on uplink of “carrier 1,” uplink of “carrier 2,” or both). The test signal may mimic or copy a “real” signal or a signal that would typically be sent to the network 402 from the UE 401 using the carrier combination.

In an example, the operational flow/algorithmic structure 400 includes, at 432, the UE 401 determining (e.g., using its power detector) a power or RSSI of the interference (e.g., on the carrier combination, on “downlink carrier 1,” “downlink carrier 2,” or both) to generate P_{interference}.

In an example, the operational flow/algorithmic structure 400 includes, at 434, the UE 401 determining the MSD value based on the REFSENS value and the P_{interference} value. In particular, the UE 401 may determine a difference between the REFSENS value and the P_{interference} value to determine the MSD value. In some examples, the UE 401 may determine the MSD value by setting the MSD value to P_{interference}, without applying the REFSENS value. Such a procedure may be useful where P_{interference} is sufficient for the network 402 to perform carrier combination scheduling.

In an example, the operational flow/algorithmic structure 400 includes, at 436, the network 402 determining whether the MSD value is acceptable. The network 402 receives the MSD value in a measurement report, like the reporting mechanism for reference signals received quality (RSRQ). The network 402 may compare the MSD value to an MSD threshold. If the MSD value does not exceed the threshold, then, at 414, the network 402 may schedule or configure the user equipment to use the carrier combination.

If the MSD value exceeds the threshold, then, at 438 of the operational flow/algorithmic structure 400, the network 402 may perform a mitigation action based on the MSD value. For example, the network 402 may downgrade transmission or reception of data, such as by only scheduling one carrier of the carrier combination to the UE 401, only scheduling a master cell group in a dual-connectivity (DC) combination, only scheduling a primary cell (PCell) operation in a carrier aggregation (CA) combination, disabling secondary cell (SCell) uplink transmission in a two-uplink (2UL) CA combination, disabling SCell downlink reception if it is impacted by either PCell uplink or both PCell and SCell uplink intermodulation product, or even not scheduling any operation for the UE 401. As another example, the network 402 may implement MSD-aware scheduling, where the modulation and coding rate configurations for the impacted downlink carriers are determined based on the user equipment's reported degradation in sensitivity. Other actions include activating a different bandwidth part within a frequency band of the band combination and/or changing the resource scheduling within the frequency band.

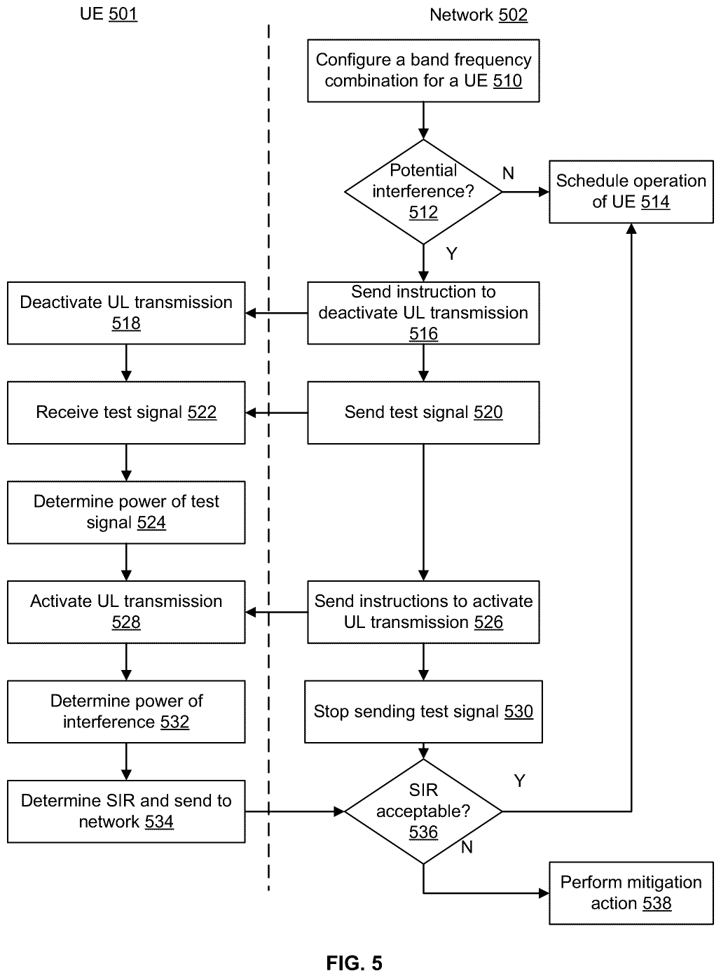

FIG. 5 illustrates an example of an operational flow/algorithmic structure 500 for performing an SIR measurement, in accordance with some embodiments. The operational flow/algorithmic structure 500 can be implemented by a UE 501 and a network 502 (e.g., performed by components thereof including, for example, processors of the UE 501 and/or processors of a base station of the network 502), in a similar manner as the implementation of the operational flow/algorithmic structure 400. Similarities exist between the operational flow/algorithmic structure 400 and the operational flow/algorithmic structure 500. In the interest of brevity, the similarities are not repeated herein but equivalently apply to the operational flow/algorithmic structure 500.

In an example, the operational flow/algorithmic structure 500 includes, at 510, the network 502 configuration a frequency band combination for the UE 501. The operational flow/algorithmic structure 500 can also include, at 512, the network 502 determining if there is potential or a likelihood of interference (e.g., self-interference, such as intermodulation or harmonic interference) that would occur between the frequency bands if the UE 501 were to operate (e.g., perform downlink or uplink operations) on the frequency bands. If there is no potential interference, the network 502 can schedule an operation of the UE 501 on the combination of frequency bands or carriers at 514 of the operational flow/algorithmic structure 500. The UE 501 may then transmit and receive signals using the carrier combination.

If the network 502 determines there is potential interference impacting any of the downlink carriers, then the network 502 may send an instruction to the UE 501 to deactivate uplink transmissions (e.g., uplink signals) at 516 of the operational flow/algorithmic structure 500. Additionally, or alternatively, the network 502 may send an indication to the UE 501 to determine the SIR value (which may include an implicit or explicit instruction to the UE 501 to deactivate uplink transmissions).

In an example, the operational flow/algorithmic structure 500 includes, at 518, the UE 501 deactivating uplink transmissions. The operational flow/algorithmic structure 500 may also include, at 520, the network 502 sending a test signal to the UE 501 (e.g., on “downlink carrier 1,” “downlink carrier 2,” or both). The test signal may mimic or copy a “real” signal or a signal that would typically be sent to the UE 501 from the network 502 using the frequency band combination. Because at least cross-band uplink transmissions are deactivated on the UE 501, at 520 of the operational flow/algorithmic structure 500, the UE 501 may receive the test signal without interference (e.g., at least self-interference caused by uplink transmissions or aggressors or downlink receptions or aggressors).

In an example, the operational flow/algorithmic structure 500 includes, at 524, the UE 501 determining (e.g., using its power detector) a power or RSSI of the test signal (e.g., on “downlink carrier 1,” “downlink carrier 2,” or both). The operational flow/algorithmic structure 500 may also include, at 526, the network 502 sending an instruction to the UE 501 to activate uplink transmissions (e.g., the uplink aggressors) that may cause the self-interference (e.g., self-generated), and the UE 501 activates uplink transmissions at operation 528 of the operational flow/algorithmic structure 500.

In an example, the operational flow/algorithmic structure 500 includes, at 530, the network 502 stops sending the test signal. Because the UE 501 is performing uplink transmissions, and no signals are received by the UE 501, the UE 501 is effectively receiving the interference without the test signal at its receive antenna.

In an example, the operational flow/algorithmic structure 500 includes, at 532, the UE 501 determining (e.g., using the power detector) a power or RSSI of the interference (e.g., on “downlink carrier 1,” “downlink carrier 2,” or both). The operational flow/algorithmic structure 500 may also include, at 534, the UE 501 (e.g., its processor) determining the SIR based on the power of the test signal and the power of the interference (e.g., by dividing the power of the test signal by the power of the interference) and sending the resulting SIR measurement to the network 502.

In an example, the operational flow/algorithmic structure 500 includes, at 536, the network 502 determining whether the SIR is acceptable. For example, the network 502 may compare the received SIR value to a threshold value. If the SIR is acceptable (e.g., greater than the threshold value), then the network 502 may schedule, at 514 of the operational flow/algorithmic structure 500, operation of the UE 501 on the combination of frequency bands. If not, then the network 502 may perform one or more mitigation actions at operation 538 of the operational flow/algorithmic structure 500.

In some cases, at least some of the interference (e.g., co-channel interference) may not be self-generated and may come from external interfering sources. As such, in some embodiments, this interference may be determined or measured during an idle mode (e.g., when the UE 501 is not performing downlink or uplink operations) while the UE 501 is configured to the carrier frequencies for the frequency band combination, as instructed by the network 502.

In some examples, the UE may include more than one receive path (e.g., each receive path including the receiver 200 or 300). For example, the UE may include a main receive path, and one or more diversity receive paths. Each path may experience different REFSENS, self-interference (e.g., because of different isolation performance), and/or inter-cell interference. In such examples, the UE may perform different measurements for each receive path, the main receive path, or one or more diversity receive paths, and determine the MSD value and/or SIR value per receive path. The UE may then report each MSD value and/or SIR value for any or all of these paths, or a mathematical combination of the MSD values and/or a mathematical combination of the SIR values for multiple paths (e.g., a maximum value, a minimum value, a mean value, a weighted mean value, a median value, a mode value, and so on). Additionally, or alternatively, the network may determine the mathematical combination of the MSD values and/or the mathematical combination of the SIR values for the multiple paths. In any case, the network may then use the mathematical combination(s) or each MSD value and/or each SIR value of the multiple paths to determine whether the collective MSD values are acceptable and/or whether the collective SIR values are acceptable. In an example, a mathematical combination can involve maximum ratio combining (MRC).

For rough, quick, or preliminary MSD estimation (and, likewise, SIR estimation), the measurements are carried out only at the main receive path. However, for more precise MSD estimation (and, likewise, SIR estimation), the measurements are carried out at both the main receive path and the one or more diversity receive paths. These measurements can be performed in parallel and processed with MRC.

Referring back to the above figures, to derive an MSD measurement or a SIR measurement, a detector of a receive path of a UE is used. Generally, this detector performs power measurements, such as RSSI-based measurements. As such, the MSD measurement and the SIR measurement can be referred to as RSSI-based MSD measurement and RSSI-based SIR measurement, respectively.

When RSSI is used, the RSSI can be measured over the configured downlink carrier bandwidth. For example, referring back to FIG. 2, the RSSI is accumulated and averaged over the frequencies spanning the entire configured downlink carrier bandwidth 264 for which the UE REFSENS 262 is measured, rather than being limited to the bandwidth of aggressor signal 272. Additionally, or alternatively, the RSSI can be measure over different pre-configured bandwidth parts (BWPs). This may enable more granular measurements, whereby the self-interference can be specific to a BWP rather than a non-configured BWP, a larger segment, or the entirety of a frequency band.

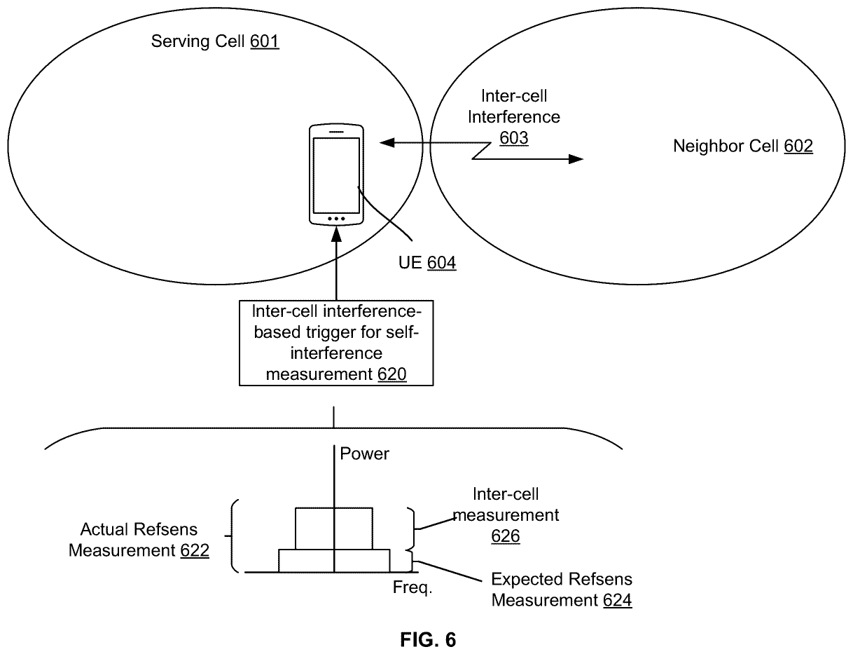

FIG. 6 illustrates an example of inter-cell interference-based trigger to perform a self-interference measurement, in accordance with some embodiments. As illustrated, a UE 604 (an example of any of the UEs described herein above) can be connected to a service cell 601 of a network (e.g., provided by a base station of the network). A neighbor cell 602 may also exist and can be provided by the network (e.g., the same or a different base station) or a different network. Inter-cell interference 603 from the neighbor cell 602 to the serving cell 601 can exist based on transmissions of the neighbor cell's 602 base station.

As described herein above, the UE 604 can be instructed by the network (e.g., the base station of the serving cell 601) to perform a self-interference measurement (e.g., MSD or SIR measurements). As part of performing the MSD measurement, the UE can perform a REFSENS measurement. As part of performing the SIR measurement, the UE can measure the power of a test signal.

The accuracy of the REFSENS measurement can depend on a number of factors including, for instance, the inter-cell interference 603. In particular, to generate the UE may have deactivated uplink transmission, while also not receiving downlink signals of the serving cell 601. The REFSENS measurement is performed in the power domain (e.g., by a power detector that measures RSSI). However, the inter-cell interference 603 may result, in the power domain, in an accurate REFSENS measurement because the UE 604 would indeed be receiving a signal (e.g., an interference signal from the neighbor cell 602).

A similar situation also exists for the SIR measurement. Here, in addition to measuring the test signal, the interference signal would also be measured by the power detector. As such, the SIR measurement can be inaccurate when the inter-cell interference 603 is present.

The presence of the inter-cell interference 603 can be detected. This detection can be performed in the power domain, which can quantify the impact to the REFSENS and SIR measurements (e.g., by estimating the power impact of the inter-cell interference 603). If the inter-cell interference 603 is detected and, depending on its impact, performing the self-interference measurement can be intelligently controlled, whereby an inter-cell interference-based trigger for self-interference measurement 620 can be defined as part of the control.

The bottom part of FIG. 6 illustrates an example detection technique. Particularly, the UE 604 can store (e.g., in its memory) an expected REFSENS measurement 624. This measurement can be a dB value previously generated in a controlled environment (e.g., in laboratory environment) or while the UE 604 was operating under other circumstances (e.g., when no neighbor cell exists). The UE 604 can generate an actual REFSENS measurement 622 by requesting to do so from or being triggered to do so by the network (e.g., the serving cell's 601 base station). The actual REFSENS measurement 622 can be generated in a similar way as in the operational flow/algorithmic structure 400. The difference between the expected REFSENS measurement 624 and the actual REFESENS measurement 622 can be an inter-cell measurement 626 that represents an estimation of the inter-cell inference impact.

The inter-cell interference-based trigger for self-interference measurement 620 can depend on the inter-cell measurement 626. If the inter-cell measurement 626 is less than a predefined threshold value (e.g., 6 dB, or some other threshold), the inter-cell interference-based trigger for self-interference measurement 620 can allow the self-interference measurement to be performed or continue to be performed. If the inter-cell measurement 626 is larger than the predefined threshold value, the inter-cell interference-based trigger for self-interference measurement 620 can prevent the self-interference measurement from being performed or can stop performing the self-interference measurement. In other words, if the inter-cell measurement is within a measurement range (e.g., within 6 dB) from the expected REFSENS of a receiver of the UE, then performing the self-interference measurement can be initiated or completed (or can be accurate enough). Otherwise, the self-interference measurement may not be performed or completed (or, if completely performed, may not be accurate enough and, thus, may not be used). Of course, different threshold values can be used for the MSD measurement and the SIR measurement. For example, the MSD measurement can be associated with a larger threshold value than that of the SIR measurement.

In an example, the UE 604 requests, from the network, a permission or a trigger to perform the inter-cell measurement 626. In turn, the network triggers or responds with a set of instructions such that the UE performs the inter-cell measurement 626. In this example, the UE can then report the inter-cell measurement 626. The network can then use it to determine the inter-cell interference-based trigger for self-interference measurement 620 and accordingly decode whether to trigger the UE to perform the self-interference measurement or not. Additionally, or alternatively, the network can trigger the UE to perform the self-interference measurement based on one or more other triggers (e.g., based on pre-screening and/or on a change to a configuration of the UE). In this case, the UE can use the inter-cell measurement 626 to locally determine whether to proceed with performing the self-interference measurement or not. If not, the UE can indicate to the network that it stopped performing the self-interference measurement and can provide the reason (e.g., the inter-cell measurement 626 is too large, and possibly report this inter-cell measurement 626). The network can override this decision by requesting the UE to proceed with the self-interference measurement.

In another example, the UE 604 may not request, from the network, a permission or a trigger to perform the inter-cell measurement 626. Instead, based on one or more other triggers, the network can instruct the UE to perform the self-interference measurement. As part of performing the self-interference measurement (e.g., as part of the operational flow/algorithmic structure 400 and/or 500), the UE can perform the inter-cell measurement 626. Once performed, the UE can use the inter-cell measurement 626 to locally determine whether to proceed with performing the self-interference measurement or not. Or the UE can report the inter-cell measurement 626 to the network that then makes the decision and instructs the UE as needed.

In the above cases, it is assumed that if the inter-cell measurement 626 exceeds the predefined threshold value, the self-interference measurement is not performed or, if performed, is not used. However, the inter-cell measurement 626 may not be used as a trigger. Instead, it may be used to adjust the self-interference measurement. For example, an adjustment value can be used based on the inter-cell measurement 626 such that the self-interference measurement becomes more accurate or reliable. The adjustment value can be a coefficient between “0” and “1.” If the inter-cell measurement 626 is smaller than the predefined value, no adjustment is made to the self-interference measurement (e.g., the coefficient is set to “0”). If the inter-cell measurement 626 is larger than the predefined value, an adjustment is made to the self-interference measurement (e.g., the coefficient is not set to “0”). For example, the coefficient is “a” (between “0” and “1”), and the adjusted self-interference measurement is generated as: “adjusted self interference measurement=measured self interference measurement−a×inter cell measurement.” The value of the coefficient can depend on the difference between the inter-cell measurement 626 and the threshold value (e.g., the larger the difference is, the larger “a” is made). To illustrate, assume the coefficient is “1.” Here, the self-interference measurement is reduced by an amount equal to the inter-cell measurement 626.

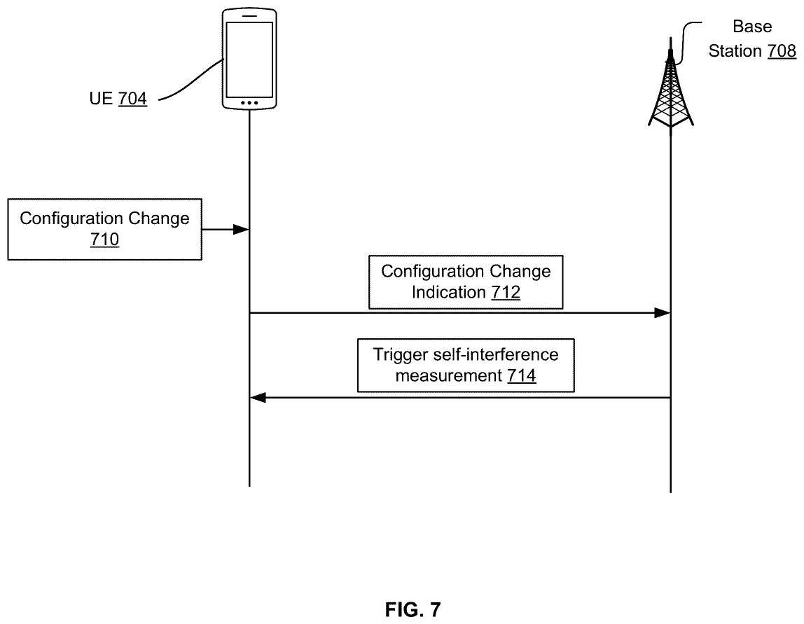

FIG. 7 illustrates an example of a UE configuration-based trigger to perform a self-interference measurement, in accordance with some embodiments. As illustrated, a UE 704 is in communication with a base station 708 of a network (e.g., the base station 708 provides a serving cell to the UE). A configuration change 710 occurs at the UE 708. The UE 704 can then send an indication 712 of the configuration change 710. The base station 708 can then trigger a self-interference measurement 714 (e.g., MSD measurement and/or SIR measurement).

In an example, the configuration change 710 can include a change to a hardware configuration of the UE 704, where this change can increase the likelihood of IMD interference and/or harmonic interference. Generally, if the change affects the self-interference coupling from main path to diversity path, it can result in a different self-interference measurement and, thus, can be used as a trigger to perform such a measurement. For instance, the change can be to one or more components of a receiver (e.g., the receiver 200 or 300) or a receive chain of the UE 704. In one illustration, the UE can change its selection of a receiver antenna panel or antenna elements within such a panel. This change can be indicated to the base station 708 to then trigger a self-interference measurement.

In an example, non-hardware configuration changes are also possible. For example, an over the air (OTA) software update to the UE 704 can change the likelihood of IMD interference and/or harmonic interference and can be used as an example of the configuration change 710. An RRC configuration change (e.g., an RRC re-configuration) can also be a trigger for the self-interference measurement (particularly for an MSD measurement), although such a change may not be initiated at the UE 704 (e.g., the UE does not indicate it to the base station 708).

In an example, the indication 712 of the configuration change 710 can be received by the base station 708 and used with one or more other triggers for the self-interference measurement by the UE 704. Other triggers can include pre-screening by the base station 708 for the likelihood of IMD interference and/or harmonic interference. Other triggers can also include an inter-cell measurement. For instance, the base station 708 can perform pre-screening in response to the indication 712 and determine that the likelihood of IMD interference and/or harmonic interference justifies performing a self-interference measurement. The UE 704 is instructed to do so and reports, as part of performing a self-interference measurement, an inter-cell measurement. Based on the inter-cell measurement, the UE can continue with or stop the self-interference measurement.

In an example, the procedure to perform an MSD measurement can be triggered semi-statically. For example, upon an RRC configuration or an RRC reconfiguration of a UE, the network can trigger the UE to perform an MSD measurement. Of course, this trigger can be used with other triggers (e.g., pre-screening, inter-cell measurement, hardware configuration change, etc.). In another example, multiple frequency band combinations are configured for the UE. The network can send a media access control (MAC) control element (CE) indicating that a frequency band combination is to be activated. The MAC CE can also trigger the UE to start or perform the self-interference measurement.

The procedure to perform a SIR measurement can be dynamically triggered. For example, the UE can be configured to periodically perform and report a SIR measurement. Additionally, or alternatively, the UE can be configured to aperiodically perform and report a SIR measurement. Here, different events can be defined for the UE. For example, based on a change to the location of the UE, or a change to a cell measurement (or beam measurement) of a serving cell, the UE can perform and report a SIR measurement.

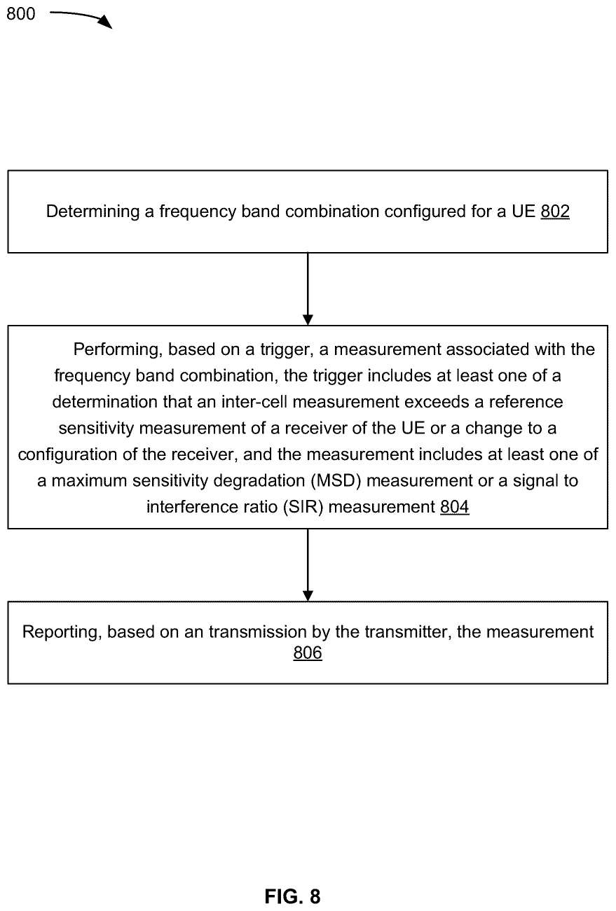

FIG. 8 illustrates an example of an operational flow/algorithmic structure 800 for performing a self-interference measurement based on a set of triggers, in accordance with some embodiments. The operational flow/algorithmic structure 800 can be implemented by a UE (e.g., performed by components thereof including, for example, processors of the UE). The UE can be any of the UE described herein. In some embodiments, the operational flow/algorithmic structure 800 may be implemented by executing instructions stored in a tangible, non-transitory, computer-readable storage medium, such as a memory of the UE. While the operational flow/algorithmic structure 800 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 800 includes, at 802, determining a frequency band combination configured for the UE. The frequency band combination can be configured via RRC signaling from a base station of a network based on a UE capability of the UE. In particular, configuration information can be received from the network via the RRC signaling and can indicate the frequency combination.

In an example, the operational flow/algorithmic structure 800 includes, at 804, performing, based on a trigger, a measurement associated with the frequency band combination. The trigger includes at least one of: a determination that an inter-cell measurement is within a measurement range from a reference sensitivity measurement of a receiver of the UE, or a change to a configuration of the receiver. The measurement includes at least one of an MSD measurement or a SIR measurement. For instance, the UE performs and reports the inter-cell measurement to the base station that then compares it to a threshold value. The threshold value can correspond to an upper bound of the measurement range. Depending on the comparison, the base station can instruct the UE to start or continue performing the self-interference measurement. In another example, the UE can perform the comparison and, depending on the outcome, request the base station to trigger the self-interference measurement or continue with performing this self-interference measurement. Similarly, the UE can indicate the change to the configuration to the base station and, in response, the base station can trigger the UE to perform the self-interference measurement. Of course, these two triggers can be used together and/or with other triggers (e.g., a pre-screening trigger).

In an example, the operational flow/algorithmic structure 800 includes, at 806, reporting, based on a transmission by a transmitter of the UE, the measurement. For example, the self-interference measurement includes a dB value for MSD and/or a dB value for SIR. The dB value(s) can be sent in a measurement report.

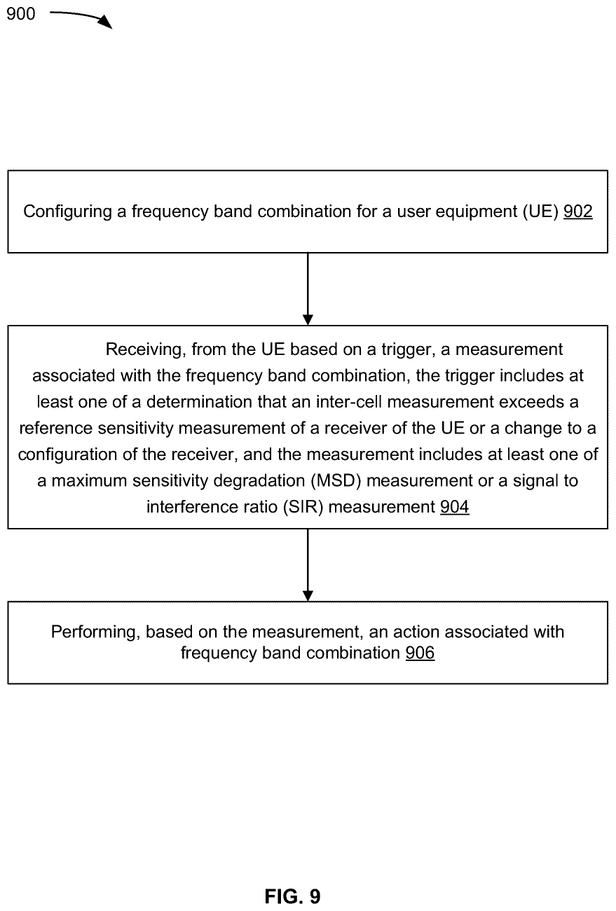

FIG. 9 illustrates another example of an operational flow/algorithmic structure 900 for performing a self-interference measurement based on a set of triggers, in accordance with some embodiments. The operational flow/algorithmic structure 900 can be implemented by a network (e.g., by a base station thereof and/or processors of the base station). The network can be any of the networks described herein. In some embodiments, the operational flow/algorithmic structure 900 may be implemented by executing instructions stored in a tangible, non-transitory, computer-readable storage medium, such as a memory of the base station. While the operational flow/algorithmic structure 900 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 900 includes, at 902, configuring a frequency band combination for a UE. The frequency band combination can be configured via RRC signaling from the base station based on a UE capability of the UE.

In an example, the operational flow/algorithmic structure 900 includes, at 904, receiving, from the UE based on a trigger, a measurement associated with the frequency band combination. As described in FIG. 8, the trigger includes at least one of: a determination that an inter-cell measurement is within a measurement range from a reference sensitivity measurement of a receiver of the UE, or a change to a configuration of the receiver. Additional triggers can also be used, such as, a pre-screening trigger. The measurement can be a self-interference measurement that includes at least one of an MSD measurement or a SIR measurement.

In an example, the operational flow/algorithmic structure 900 includes, at 906, performing, based on the measurement, an action associated with frequency band combination. The base station can compare the MSD measurement and/or the SIR measurement to a predefined threshold value (the same threshold value can be used for both measurement types, or a specific threshold value can be used per measurement type). If the comparison indicates an acceptable MSD and/or an acceptable SIR, the base station can activate frequency bands of the frequency band combination for the UE and/or can schedule uplink and/or downlink communications on the frequency band combination. Otherwise, a mitigation action can be performed as described herein above.

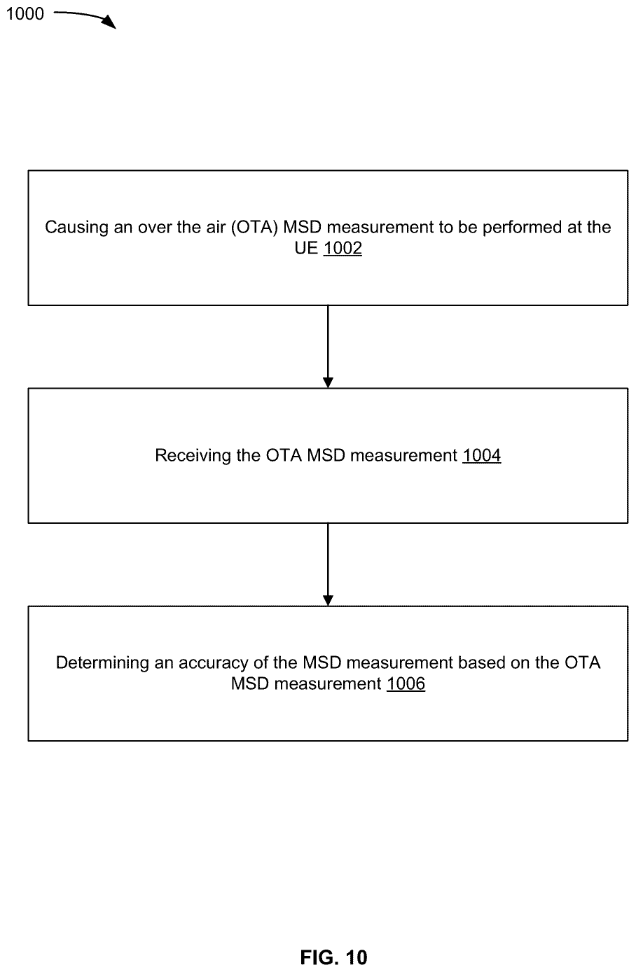

FIG. 10 illustrates another example of an operational flow/algorithmic structure 1000 for validating an RSSI-based MSD measurement, in accordance with some embodiments. The operational flow/algorithmic structure 1000 can be implemented by a network (e.g., by a base station thereof and/or processors of the base station). The network can be any of the networks described herein. In some embodiments, the operational flow/algorithmic structure 1000 may be implemented by executing instructions stored in a tangible, non-transitory, computer-readable storage medium, such as a memory of the base station. While the operational flow/algorithmic structure 1000 is described using steps in a specific sequence, it should be understood that the present disclosure contemplates that the described steps may be performed in different sequences than the sequence illustrated, and certain described steps may be omitted or not performed altogether.

As described herein above, a UE performs an MSD measurement in the power domain for a frequency band combination. When RSSI is used, the MSD measurement can be referred to as RSSI-based MSD measurement. The UE can report the RSSI-based MSD measurement to the network. In turn, the network can validate the RSSI-based MSD measurement. The validation can indicate the accuracy of the RSSI-based MSD measurement. If valid, the network can use the RSSI-based MSD measurement to manage, at least in part, the UE's use of the frequency band combination. The use of an inter-cell measurement was previously described. This use can be considered as one example of the validation. An additional or an alternative example of the validation involves the use of an OTA MSD measurement as described herein next.

The base station can select a band combination supported by the UE with known an MSD issue, such as an MSD caused by uplink harmonic interference or IMD (e.g., the MSD issue can be determined using the pre-screening process described above). The same carrier configuration for both OTA MSD measurement and UE RSSI-based MSD measurement is used. The OTA MSD measurement is based on the procedure similar to REFSENS measurement where the wanted signal power level difference between the reception of a wanted signal with uplink interference (e.g., the uplink transmission is activated) and without the uplink interference (e.g., the uplink transmission is deactivated) to achieve the same downlink throughput represents the OTA MSD measurement. The UE RSSI-based MSD value needs to be within a dB value range from OTA MSD measurement to be determined as having an acceptable accuracy.

In an example, the operational flow/algorithmic structure 1000 includes, at 1002, the base station causing an OTA MSD measurement to be performed at the UE. For example, the base station sends a set of instructions to the UE to do so. The set of instructions can be triggered using different triggers, such as the ones described herein above, and/or or upon the receipt of the RSSI-based MSD measurement. The base station can instruct the UE to deactivate its uplink transmission. Thereafter, the base station can send a downlink signal (referred to as a downlink wanted signal) on one or more of the frequency bands of the frequency band combination. The downlink signal is transmitted at a first power. The UE then detects and decodes the downlink signal and measure a corresponding throughput. The throughput can be compared to a target throughput. This comparison can be performed by the base station or the UE. To be performed by the base station, the UE can report its throughput to the base station. To be performed by the UE, the base station can indicate the target throughput to the UE (e.g., as part of the set of instructions) or the target throughput can be pre-stored by the UE. In this case, the UE indicates the outcome of the comparison to the base station. In both cases, if the measured throughput exceeds the target throughput, the first power can be reduced to a second power. Conversely, if the measured throughput is lower than the target throughput, the first power can be increased to a second power. Particularly, the base station transmits the downlink signal again at the second power. These steps can be repeated until the measured throughput matches the target throughput (e.g., is within a throughput range therefrom). At that point, the downlink signal transmission power that resulted in the throughput match is determined to be a REFSENS of the UE's receiver to achieve the target throughput. Next, the base station instructs the UE to activate its uplink transmission at a certain power (e.g., at the maximum power PCMAX). The base station then transmits again the downlink signal at the last downlink signal transmission power and instructs the UE to measure an SNR. Like above, the measured SNR can be compared to a target SNR (by the UE or the base station), and the base station can adjust the transmission power and send again the downlink signal at the adjusted power until the measured SNR matches a target SNR. This target SNR is also associated with the target throughput. The adjustment to the transmission power until the target SNR is met represents the OTA MSD measurement.

In an example, the operational flow/algorithmic structure 1000 includes, at 1004, the base station determining the OTA MSD measurement. The OTA MSD measurement can be computed locally by the base station or received from the UE. The UE may also determine the OTA MSD measurement.

In an example, the operational flow/algorithmic structure 1000 includes, at 1006, determining an accuracy of the MSD measurement (e.g., the RSSI-based MSD measurement) based on the OTA MSD measurement. For example, the base station can compare the two. If the RSSI-based MSD measurement is within a measurement range of the OTA MSD (e.g., the different is smaller than a predefined threshold value), the base station can determine that the accuracy of the RSSI-based MSD measurement is sufficient and can proceed with using it to manage, at least in part, the UE's use of the frequency band. Otherwise, the base station can determine that the accuracy is unacceptable and may not proceed with using the RSSI-based MSD measurement to manage, at least in part, the UE's use of the frequency band. The UE can also determine this accuracy.

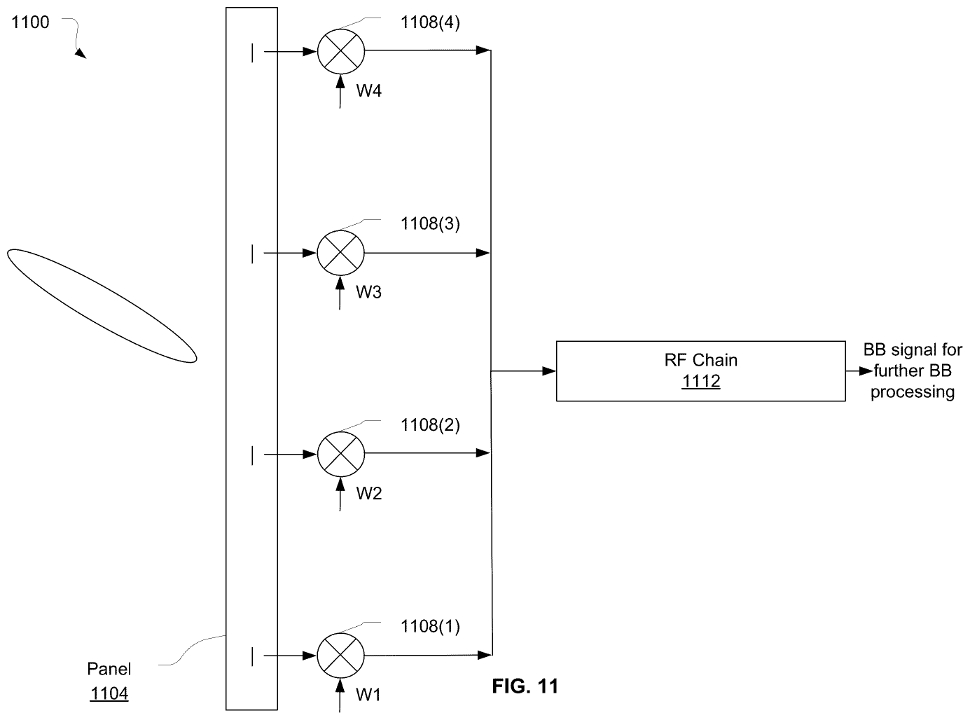

FIG. 11 illustrates receive components 1100 of a UE (e.g., the UE 104 of FIG. 1 and any other UE described herein capable of performing and sending a self-interference measurement report), in accordance with some embodiments. The receive components 1100 may include an antenna panel 1104 that includes a number of antenna elements. The panel 1104 is shown with four antenna elements, but other embodiments may include other numbers. Multiple antenna panels may also be included.

The antenna panel 1104 may be coupled to analog beamforming (BF) components that include a number of phase shifters 1108(1)-1108(4). The phase shifters 1108(1)-1108(4) may be coupled with a radio-frequency (RF) chain 1109. The RF chain 1109 may amplify a receive analog RF signal, down-convert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values to the phase shifters 1108(1)-1108(4) to provide a receive beam at the antenna panel 1104. These BF weights may be determined based on the channel-based beamforming.

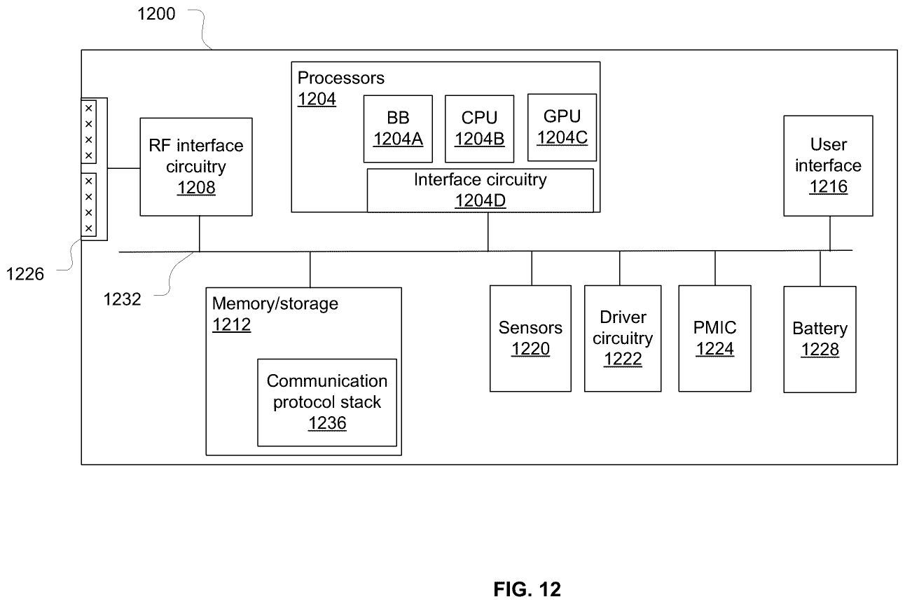

FIG. 12 illustrates a UE 1200 in accordance with some embodiments. The UE 1200 may be similar to and substantially interchangeable with the UE 104 or 106 or any other UE described herein capable of performing and sending a self-interference measurement report.

The UE 1200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1200 may include processors 1204, RF interface circuitry 1208, memory/storage 1212, user interface 1216, sensors 1220, driver circuitry 1222, power management integrated circuit (PMIC) 1224, antenna 1226, and battery 1228. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangement of the components shown may occur in other implementations.

The components of the UE 1200 may be coupled with various other components over one or more interconnects 1232, which may represent any type of interface, input/output, bus (local, system, or expansion), transmission line, trace, or optical connection that allows various circuit components (on common or different chips or chipsets) to interact with one another.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage 1212 to cause the UE 1200 to perform delay-adaptive operations as described herein. The processors 1204 may also include interface circuitry 1204D to communicatively couple the processor circuitry with one or more other components of the UE 1200.

In some embodiments, the baseband processor circuitry 1204A may access a communication protocol stack 1236 in the memory/storage 1212 to communicate over a 3GPP compatible network. In general, the baseband processor circuitry 1204A may access the communication protocol stack 1236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1208.

The baseband processor circuitry 1204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1212 may include one or more non-transitory, computer-readable media that includes instructions (for example, communication protocol stack 1236) that may be executed by one or more of the processors 1204 to cause the UE 1200 to perform various delay-adaptive operations described herein.

The memory/storage 1212 includes any type of volatile or non-volatile memory that may be distributed throughout the UE 1200. In some embodiments, some of the memory/storage 1212 may be located on the processors 1204 themselves (for example, memory/storage 1212 may be part of a chipset that corresponds to the baseband processor circuitry 1204A), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1208 may include transceiver circuitry and a radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1226 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1226.

In various embodiments, the RF interface circuitry 1208 may be configured to transmit/receive signals in a manner compatible with NR access technologies.

The antenna 1226 may include antenna elements to convert electrical signals into radio waves to travel through the air and to convert received radio waves into electrical signals. The antenna elements may be arranged into one or more antenna panels. The antenna 1226 may have antenna panels that are omnidirectional, directional, or a combination thereof to enable beamforming and multiple input, multiple output communications. The antenna 1226 may include microstrip antennas, printed antennas fabricated on the surface of one or more printed circuit boards, patch antennas, or phased array antennas. The antenna 1226 may have one or more panels designed for specific frequency bands including bands in FR1 or FR2.

The user interface 1216 includes various input/output (I/O) devices designed to enable user interaction with the UE 1200. The user interface 1216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1200.

The sensors 1220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various input/output (I/O) devices that may be present within, or connected to, the UE 1200. For example, driver circuitry 1222 may include a display driver to control and allow access to a display device, a touchscreen driver to control and allow access to a touchscreen interface, sensor drivers to obtain sensor readings of sensors 1220 and control and allow access to sensors 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage power provided to various components of the UE 1200. In particular, with respect to the processors 1204, the PMIC 1224 may control power-source selection, voltage scaling, battery charging, or DC-to-DC conversion.

A battery 1228 may power the UE 1200, although in some examples the UE 1200 may be mounted deployed in a fixed location and may have a power supply coupled to an electrical grid. The battery 1228 may be a lithium ion battery, a metal-air battery, such as a zinc-air battery, an aluminum-air battery, a lithium-air battery, and the like. In some implementations, such as in vehicle-based applications, the battery 1228 may be a typical lead-acid automotive battery.

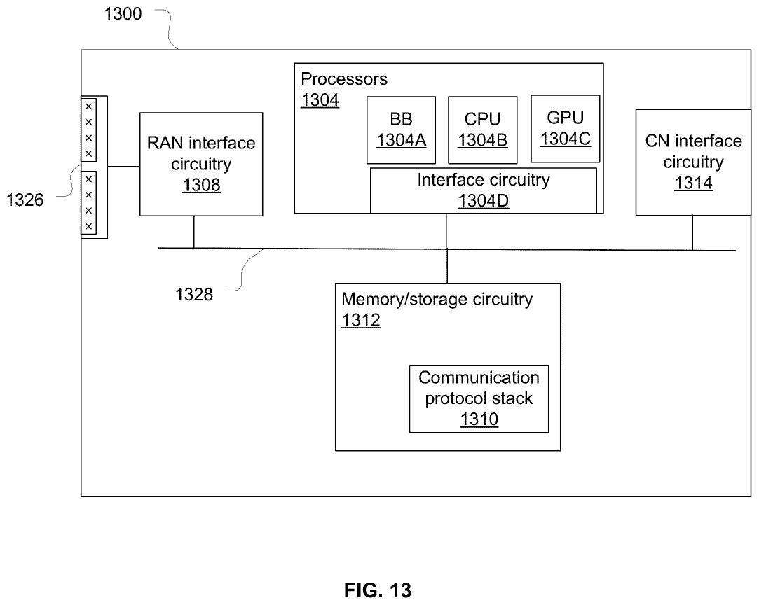

FIG. 13 illustrates a network device 1300 in accordance with some embodiments. The network device 1300 may be similar to and substantially interchangeable with base station 108 or a device of the core network 112 or external data network 120 capable of receiving a self-interference measurement report of a UE and managing, at least in part, the UE's use of frequency bands based on the self-interference measurement report.

The network device 1300 may include processors 1304, RF interface circuitry 1308 (if implemented as a base station), core network (CN) interface circuitry 1314, memory/storage circuitry 1312, and antenna structure 1326.

The components of the network device 1300 may be coupled with various other components over one or more interconnects 1328.

The processors 1304, RF interface circuitry 1308, memory/storage circuitry 1312 (including communication protocol stack 1310), antenna structure 1326, and interconnects 1328 may be similar to like-named elements shown and described with respect to FIG. 12.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage circuitry 1312 to cause the network device 1300 to perform operations described herein. The processors 1304 may also include interface circuitry 1304D to communicatively couple the processor circuitry with one or more other components of the network device 1300.

The CN interface circuitry 1314 may provide connectivity to a core network, for example, a 5th Generation Core network (5GC) using a 5GC-compatible network interface protocol such as carrier Ethernet protocols, or some other suitable protocol. Network connectivity may be provided to/from the network device 1300 via a fiber optic or wireless backhaul. The CN interface circuitry 1314 may include one or more dedicated processors or FPGAs to communicate using one or more of the aforementioned protocols. In some implementations, the CN interface circuitry 1314 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method implemented on an apparatus that includes a receiver; a transmitter; and processing circuitry communicatively couple with the receiver and the transmitter. The method includes determining a frequency band combination configured for a user equipment (UE); performing, based on a trigger, a measurement associated with the frequency band combination, wherein: the trigger includes at least one of: a determination that an inter-cell measurement is within a measurement range from a reference sensitivity (REFSENS) measurement of the receiver, or a change to a configuration of the receiver, and the measurement includes at least one of a maximum sensitivity degradation (MSD) measurement or a signal to interference ratio (SIR) measurement; and reporting, based on a transmission by the transmitter, the measurement.

Example 2 includes a method comprising: receiving, from a network, configuration information; determining, based on the configuration information, a frequency band combination configured for a user equipment (UE); performing, based on a trigger, a measurement associated with the frequency band combination, wherein: the trigger includes at least one of: a determination that an inter-cell measurement is within a measurement range from a reference sensitivity (REFSENS) measurement of a receiver of the UE, or a change to a configuration of the receiver, and the measurement includes at least one of a maximum sensitivity degradation (MSD) measurement or a signal to interference ratio (SIR) measurement; and reporting the measurement.

Example 3 includes method comprising: configuring a frequency band combination for a user equipment (UE); receiving, from the UE based on a trigger, a measurement associated with the frequency band combination, wherein: the trigger includes at least one of: a determination that an inter-cell measurement is within a measurement range from a reference sensitivity (REFSENS) measurement of a receiver of the UE, or a change to a configuration of the receiver, and the measurement includes at least one of a maximum sensitivity degradation (MSD) measurement or a signal to interference ratio (SIR) measurement; and performing, based on the measurement, an action associated with frequency band combination.

Example 4 includes the method of any preceding example, wherein the inter-cell measurement includes a received signal strength indicator (RSSI) measurement performed while uplink transmission using at least one frequency band of the frequency band combination is deactivated and while no downlink signal is scheduled on the frequency band combination by a base station for the UE.

Example 5 includes the method of example 4, further comprising: determining that a difference between RSSI measurement and the REFSENS measurement is smaller than a predefined threshold value, wherein at least one of the MSD measurement or the SIR measurement is performed based on the difference being smaller than the predefined threshold value.

Example 6 includes the method of any preceding example, wherein the measurement is reported to a base station, and further comprising: causing a first indication of the change to the configuration of the receiver to be sent to the base station; and processing a second indication of performing the measurement, wherein the second indication is received from the base station based on the first indication, and wherein at least one of the MSD measurement or the SIR measurement is performed based on the second indication.

Example 7 includes the method of any preceding example, further comprising: processing radio resource control (RRC) signaling associated with configuring or reconfiguring the UE, wherein the MSD measurement is performed based on the RRC signaling.

Example 8 includes the method of any preceding example, further comprising: causing periodic SIR measurements for the frequency band combination to be reported periodically.

Example 9 includes the method of any of examples 1-7, wherein SIR measurement is reported aperiodically based on the trigger.

Example 10 includes the method of any preceding example, further comprising: receiving a media access control (MAC) control element (CE) indicating that the frequency band combination is to be activated, wherein the measurement is performed based on the MAC CE.

Example 11 includes the method of any preceding example, wherein the at least one of the MSD measurement or the SIR measurement is generated based on a received signal strength indicator (RSSI) measurement performed on a downlink carrier bandwidth corresponding to at least a frequency band of the frequency band combination.

Example 12 includes the method of any preceding example, wherein the at least one of the MSD measurement or the SIR measurement is generated based on a received signal strength indicator (RSSI) measurement performed on one or more configured bandwidth parts corresponding to at least a frequency band of the frequency band combination.

Example 13 includes the method of any preceding example, wherein the at least one of the MSD measurement or the SIR measurement is generated based on a received signal strength indicator (RSSI) measurement performed on symbols that are unassociated with a downlink reference signal configured for the UE.

Example 14 includes the method of any preceding example, wherein the measurement is reported in a measurement report to a base station.

Example 15 includes the method of any preceding example, further comprising: performing an over the air (OTA) MSD measurement associated with the frequency band combination; and determining that the MSD measurement is within a predefined measurement range from the OTA MSD measurement.

Example 16 includes the method of example 15, wherein the MSD measurement is reported based on the MSD measurement being within the predefined measurement range from the OTA MSD measurement.

Example 17 includes the method of any preceding example, further comprising: performing an over the air (OTA) MSD measurement associated with the frequency band combination; and causing the OTA MSD measurement to be reported.

Example 18 includes the method of any preceding example, further comprising: causing an over the air (OTA) MSD measurement to be performed at the UE; determining the OTA MSD measurement; and determining an accuracy of the MSD measurement based on the OTA MSD measurement.

Example 19 includes the method of example 18, wherein the accuracy is determined based on a comparison of the MSD measurement and the OTA measurement, and wherein the action is performed based on the accuracy.

Example 20 includes the method of any preceding example, further comprising: receiving, from the UE, a first indication of the change to the configuration of the receiver; and sending, to the UE based on the first indication, a second indication to perform the measurement, wherein at least one of the MSD measurement or the SIR measurement is performed based on the second indication.

Example 21 includes a user equipment (UE) comprising: one or more processors; and one or more memory storing instructions that, upon execution by the one or more processors, configure the UE to perform a method described in or related to any of the preceding examples.

Example 22 includes one or more computer-readable media storing instructions that, when executed on a user equipment (UE), cause the UE to perform operations comprising those of a method described in or related to any of the preceding examples.

Example 23 includes a device comprising means to perform one or more elements of a method described in or related to any of the preceding examples.

Example 24 includes one or more non-transitory computer-readable media comprising instructions to cause a device, upon execution of the instructions by one or more processors of the device, to perform one or more elements of a method described in or related to any of the preceding examples.

Example 25 includes a device comprising logic, modules, or processing circuitry configured to perform one or more elements of a method described in or related to any of the preceding examples.

Example 26 includes a device, a network, a base station, or a system comprising: one or more processors and one or more computer-readable media comprising instructions that, when executed by the one or more processors, cause the one or more processors to perform one or more elements of a method described in or related to any of the preceding examples.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

Applicant hereby claims:

1. An apparatus comprising:
a receiver;
a transmitter; and
processing circuitry communicatively coupled with the receiver and the transmitter and configured to:
determine a frequency band combination configured for a user equipment (UE);
perform, based on a trigger, a measurement associated with the frequency band combination, wherein:
the trigger includes at least one of: a determination that an inter-cell measurement is within a measurement range from a reference sensitivity (REFSENS) measurement of the receiver, or a change to a configuration of the receiver, and
the measurement includes at least one of a maximum sensitivity degradation (MSD) measurement or a signal to interference ratio (SIR) measurement; and
report, based on a transmission by the transmitter, the measurement.

2. The apparatus of claim 1, wherein the inter-cell measurement includes a received signal strength indicator (RSSI) measurement performed while uplink transmission using at least one frequency band of the frequency band combination is deactivated and while no downlink signal is scheduled on the frequency band combination by a base station for the UE.

3. The apparatus of claim 2, wherein the processing circuitry is further configured to:
determine that a difference between RSSI measurement and the REFSENS measurement is smaller than a predefined threshold value, wherein at least one of the MSD measurement or the SIR measurement is performed based on the difference being smaller than the predefined threshold value.

4. The apparatus of claim 1, wherein the measurement is reported to a base station, and wherein the processing circuitry is further configured to:
cause a first indication of the change to the configuration of the receiver to be sent to the base station; and
process a second indication of performing the measurement, wherein the second indication is received from the base station based on the first indication, and wherein at least one of the MSD measurement or the SIR measurement is performed based on the second indication.

5. The apparatus of claim 1, wherein the processing circuitry is further configured to:
process radio resource control (RRC) signaling associated with configuring or reconfiguring the UE, wherein the MSD measurement is performed based on the RRC signaling.

6. The apparatus of claim 1, wherein the processing circuitry is further configured to:
cause periodic SIR measurements for the frequency band combination to be reported periodically.

7. The apparatus of claim 1, wherein the SIR measurement is reported aperiodically based on the trigger.

8. The apparatus of claim 1, wherein the processing circuitry is further configured to:
receive a media access control (MAC) control element (CE) indicating that the frequency band combination is to be activated, wherein the measurement is performed based on the MAC CE.

9. The apparatus of claim 1, wherein the at least one of the MSD measurement or the SIR measurement is generated based on a received signal strength indicator (RSSI) measurement performed on a downlink carrier bandwidth corresponding to at least a frequency band of the frequency band combination.

10. The apparatus of claim 1, wherein the at least one of the MSD measurement or the SIR measurement is generated based on a received signal strength indicator (RSSI) measurement performed on one or more configured bandwidth parts corresponding to at least a frequency band of the frequency band combination.

11. The apparatus of claim 1, wherein the at least one of the MSD measurement or the SIR measurement is generated based on a received signal strength indicator (RSSI) measurement performed on symbols that are unassociated with a downlink reference signal configured for the UE.

12. One or more computer-readable storage media storing instructions, that upon execution by processing circuitry, cause the processing circuitry to perform operations comprising:
determining, based on configuration information received from a network, a frequency band combination configured for a user equipment (UE);
performing, based on a trigger, a measurement associated with the frequency band combination, wherein:
the trigger includes at least one of: a determination that an inter-cell measurement is within a measurement range from a reference sensitivity (REFSENS) measurement of a receiver of the UE, or a change to a configuration of the receiver, and
the measurement includes at least one of a maximum sensitivity degradation (MSD) measurement or a signal to interference ratio (SIR) measurement; and
reporting the measurement.

13. The one or more computer-readable storage media of claim 12, wherein the measurement is reported in a measurement report to a base station.

14. The one or more computer-readable storage media of claim 12, wherein the operations further comprise:
performing an over the air (OTA) MSD measurement associated with the frequency band combination; and
determining that the MSD measurement is within a predefined measurement range from the OTA MSD measurement.

15. The one or more computer-readable storage media of claim 14, wherein the MSD measurement is reported based on the MSD measurement being within the predefined measurement range from the OTA MSD measurement.

16. The one or more computer-readable storage media of claim 12, wherein the operations further comprise:
performing an over the air (OTA) MSD measurement associated with the frequency band combination; and
causing the OTA MSD measurement to be reported.

17. A method comprising:
configuring a frequency band combination for a user equipment (UE);
receiving, from the UE based on a trigger, a measurement associated with the frequency band combination, wherein:
the trigger includes at least one of: a determination that an inter-cell measurement is within a measurement range from a reference sensitivity (REFSENS) measurement of a receiver of the UE, or a change to a configuration of the receiver, and
the measurement includes at least one of a maximum sensitivity degradation (MSD) measurement or a signal to interference ratio (SIR) measurement; and
performing, based on the measurement, an action associated with the frequency band combination.

18. The method of claim 17, further comprising:
causing an over the air (OTA) MSD measurement to be performed at the UE;
determining the OTA MSD measurement; and
determining an accuracy of the MSD measurement based on the OTA MSD measurement.

19. The method of claim 18, wherein the accuracy is determined based on a comparison of the MSD measurement and the OTA measurement, and wherein the action is performed based on the accuracy.

20. The method of claim 17, further comprising:
receiving, from the UE, a first indication of the change to the configuration of the receiver; and
sending, to the UE based on the first indication, a second indication to perform the measurement, wherein at least one of the MSD measurement or the SIR measurement is performed based on the second indication.
